(19) United States
(12) Patent Application Publication
(10) Pub. No.: US 2003/0133444 A1
(43) Pub. Date: Jul. 17, 2003

(54) RE-PROVISIONING METHOD

(76) Inventors: TAKASHI WAKAMATSU, KAWASAKI-SHI (JP); MAKIKO SUZUKI, KAWASAKI-SHI (JP)

Correspondence Address: KATTEN MUCHIN ZAVIS ROSENMAN, 575 MADISON AVENUE, NEW YORK, NY, 10022-2585, US

(21) Appl. No.: 09/173,525

(22) Filed: Oct. 15, 1998

(30) Foreign Application Priority Data
May 6, 1998 (JP) 10-123375

(51) Int. Cl. H04L 12/66

(52) U.S. Cl. 370/355; 370/357

(57) ABSTRACT

Provided is a re-provisioning method including a plurality of processes performed between a local exchange and an access network connected by a V5 interface, comprising the steps of: providing messages for synchronizing between the local exchange and the access network; and processing each of the plurality of processes synchronously based on the message. For the conventional V5 specifications which are unclear, a message used to synchronize the operations of the local exchange and the access network is defined so that the re-provisioning method (re-provisioning processes) can be performed by the local exchange and the access network synchronously.

### BACKGROUND OF THE INVENTION

1. Field of the Invention

The present invention relates to a re-provisioning method for a local exchange (LE) and an access network (AN) which are connected together via a V5 interface.

2. Related Arts

FIG. 14 is a specific diagram showing a network system in which is included a local exchange (hereinafter referred to simply as an LE) and an access network (hereinafter referred to simply as an AN). In FIG. 14, ANs, which correspond to multiplexers for subscriber lines, are located between LEs and subscriber terminals. With this network configuration, a public service terminal network (PSTN) and an integrated service digital network (ISDN) can be connected to LEs using a common line.

The specifications for the interfaces used to join the LEs, which are terminals in an exchange network, and the ANs is given in the V5 interface advisory issued by the ITU-T (International Telecommunication Union-Telecommunication standard sector).

The V5 interface includes V5.1 and V5.2 interface specifications, which are established by ITU-T advisories G964 (V5.1) and G965 (V5.2).

As the basic unit for the V5 interface, 2.048 Mbps (64 kbps×32 time slots) is employed. Bearer data for one channel, such as speech data for a telephone and B channel data for an ISDN terminal, are assigned to one time slot (64 kbps) and transmitted.

Control data exchanged by the LEs and ANs are transmitted via a specific time slot called a communication channel.

FIG. 15 is a diagram showing a transfer format for 2.048 Mbps. In FIG. 15, TS0 is a frame synchronization time slot; TS1 through TS14 and TS17 through TS30 are bearer data time slots; and TS15, TS16 and TS31 are bearer data time slots or communication channel time slots.

In each AN is stored information (provisioning data) concerning subscriber terminals connected thereto, and in each LE is stored provisioning data held by all the connected ANs. The provisioning data are various types of information concerning the attribute of a subscriber terminal, such as the type of line provided for the subscriber terminal (an analog line or a digital line).

The provisioning data are identified as parameters called variant values by both the LE and ANS.

When a new subscriber is added to the network or the attribute of a subscriber is changed, the provisioning data must be updated. When the provisioning data are updated, accordingly, the variant values are changed. Therefore, when the provisioning data are updated, the variant values identified by the LE and the ANs must also be changed.

The changing of the variant value, i.e., the updating of the provisioning data, is called “re-provisioning.” The processes required for the re-provisioning involving the LE and the AN are called re-provisioning processes. This re-provisioning processes are defined by the ETS (European Telecommunication Institute Standard). Specifically, the re-provisioning processes for the V5.1 interface and the V5.2 interface is described in chapter 14.5 of ETS 300 324-1 and chapter 15.5 of ETS 300 347-1, which are issued by the ETS. ETS 300 324-1 and ETS 300 347-1 carry the same contents as the ITU-T advisories G964 and G965. Furthermore, a supplementary explanation is given in Annex C 11) and 12) of ETS 300 324-1 and in Annex C 11) and 12) of ETS 300 347-1. For the references, documents for ETS 300 324-1 and ETS 300 347-1 are given below:

ETS 300 324-1:

Signaling Protocols and Switching (SPS);

V interfaces for a digital local Exchange (LE)

V5.1 interface for the support of an Access Network (AN)

Part 1: V5.1 interface specification

ETS 300 347-1:

Signaling Protocols and Switching (SPS);

V interfaces for a digital Local Exchange (LE)

V5.2 interface for the support of an Access Network (AN)

Part 1: V5.2 interface specification

FIGS. 16A and 16B are flowcharts for the re-provisioning processes described in the above documents. FIG. 16A is a flowchart for the re-provisioning processes performed by the LE, and FIG. 16B is a flowchart showing the re-provisioning processes performed by an AN.

In FIG. 16A, first, at step S11 the LE blocks those ports (ports blocked) provided for individual subscribers for which re-provisioning processes are to be performed in order to prevent those subscriber terminals from performing a normal network operation (e.g., the use of a telephone) during the re-provisioning processes.

At step S12 the LE transmits to the AN a variant change message (SWITCH-OVER-TO-NEW-VARIANT) to start a re-provisioning process.

Upon receiving the variant change message (SWITCH-OVER-TO-NEW-VARIANT), in addition to the port blocking performed at step S11, the AN blocks the ports for which the re-provisioning process is to be performed (step S13) and then transmits to the LE a re-provisioning start message (RE-PROVISIONING-STARTED) to notify the LE the re-provisioning process has been begun (step S14). At step S15 the AN starts the re-provisioning process.

Upon receiving the re-provisioning process start message (RE-PROVISIONING-STARTED) from the AN, the LE also starts re-provisioning process, i.e., the processing for changing the variant value (step S16).

When the re-provisioning process at steps S15 and S16 have been terminated, in order to unblock the blocked ports, at step S17 the AN and the LE exchange port unblock messages (UNBLOCK PORTS). Both the LE and the AN upon receiving the port unblock message (UNBLOCK PORTS) from the other, unblock the ports which have been blocked.

In FIG. 16B, first, at step S21 the AN transmits a variant change message (SWITCH-OVER-TO-NEW-VARIANT) to the LE. Upon receiving the variant change message (SWITCH-OVER-TO-NEW-VARIANT), the LE transmits to the AN a blocking start message (BLOCKING STARTED) to notify the AN that the port blocking has begun (step S22), and blocks the ports (step S23). Upon receiving the blocking start message (BLOCKING STARTED), in addition to the blocking performed at step S23, the AN blocks ports for which re-provisioning process is to be performed (step S24). When all the ports for which re-provisioning process is to be performed are blocked, at step S25 the LE transmits the variant change message (SWITCH-OVER-TO-NEW-VARIANT) to the AN. Upon receiving this message, the AN transmits to the LE a re-provisioning start message (RE-PROVISIONING-STARTED) to notify the LE that the re-provisioning process has begun (step S26). And at step S27 the AN starts the re-provisioning process.

Upon receiving the re-provisioning start message (RE-PROVISIONING-STARTED) from the AN, the LE also starts re-provisioning process (step S28).

When the re-provisioning process at steps S27 and S28 have been terminated, at step S29 the AN and the LE exchange port unblocking messages (UNBLOCK-PORTS) to unblock the ports which have been blocked. Both the LE and the AN, upon receiving the port unblocking message (UNBLOCK-PORTS) from the other, unblock the blocked ports.

However, when the re-provisioning processes shown in FIG. 16 is performed, the following problems are encountered.

The first problem will now be presented by explaining by employing the existing conditions at the LE and the AN.

According to the above documents, a plurality of states are defined for the AN and the LE for re-provisioning processes. Specifically, the following three states are defined for the AN:

AN0: normal (during a normal operation, not ready for re-provisioning)

AN1: ready for re-provisioning

AN2: re-provisioning is in process

The following four states are defined for the LE:

LE0: normal (during a normal operation, not ready for re-provisioning)

LE1: ready for re-provisioning, and ports are currently employed

LE2: ready for re-provisioning, and ports are currently blocked

LE3: re-provisioning is in process

Therefore, to initiate the re-provisioning processes, the AN and the LE must be in the respective states AN1 and LE1. That is, before the variant change messages (SWITCH-OVER-TO-NEW-VARIANT) are received at steps S12 and S21 in FIGS. 16A and 16B, the AN and the LE must be transited to the states AN1 and LE1, which are standby states for re-provisioning processes.

In FIGS. 17 and 18 are shown state tables 66 and 67 for the AN and the LE given in chapter 14.5 of ETS 300 324-1. As is apparent from the tables 66 and 67, in order for the AN and the LE to be transited from state AN0 to AN1 and from state LE0 to LE1, the event “data set available: dsa” must occur inside both an the AN and the LE.

However, how the event “data set available: dsa” should synchronously occur during the re-provisioning processes is not described in the documents ETS 300 324-1 and ETS 300 347-1 (hereinafter referred to as the V5 specifications). In other words, according to the re-provisioning processes in accordance with the V5 specifications, the state transition must be performed independently for the AN and the LE. Therefore, as the first problem, state transition can not be performed in synchronization with the re-provisioning processes.

The second problem is that a message which is employed to block ports (Ports Blocked) at step S11 is not specified. In the V5 interface, a user port block message (User port block) is defined as a conventional message for blocking ports. However, the user port block message (User port block) is generated for each subscriber terminal. When such a conventional message is employed to block the ports of the subscriber terminals, messages in a number equivalent to the number of subscriber terminals which are to be blocked are required. Therefore, for the re-provisioning processes during which ports for many subscriber terminals (e.g. several thousands of subscriber terminals) must be blocked, the employment of the conventional user port block message (User port block) is not realistic.

After the re-provisioning process is terminated, at steps S17 and S29 in FIG. 16 the LE and the AN exchange port unblocking messages (UNBLOCK PORTS) to unblock the blocked ports.

The third problem is that it is not clear just when the re-provisioning process is terminated. After the re-provisioning process is terminated, the AN and the LE must be returned to the normal operating state by transiting from the state AN2 to AN0 and from the state LE3 to LE0. According to the tables 66 and 67 in FIGS. 17 and 18, such state transition is performed when the event “Re-provisioning completed” occurs. However, how the event “Re-provisioning completed” occurs is not specified in the re-provisioning processes according to the V5 specification.

The fourth problem is that the port unblock message (UNBLOCK PORTS), which is used to unblock ports after the re-provisioning process has been terminated, is not specifically defined in the re-provisioning processes in the V5 specifications. For the V5 interface, the user port unblock message (User port unblock) is specified as a conventional message for the blocking of ports.

However, the user port unblock message (User Port unblock) is generated for each subscriber terminal. When such a conventional message is employed to block the ports of the subscriber terminals, messages in a number equivalent to the number of subscriber terminals which are to be blocked are required. Therefore, the employment of the conventional user port unblock message (User port unblock) is not realistic for the re-provisioning processes during which ports for many subscriber terminals (e.g., several thousands of subscriber terminals) must be blocked.

### SUMMARY OF THE INVENTION

To resolve the above problems, it is, therefore, one objective of the present invention to provide a re-provisioning method whereby LEs and ANs can synchronously perform re-provisioning processes for the V5 interface.

It is another objective of the present invention to make clear what re-provisioning processes must be performed for the V5 interface, which is defined in chapter 14.5 of ETS 300 324-1 and chapter 15.5 of ETS 300 347-1.

To achieve the above objectives, according to the present invention, provided is a re-provisioning method including a plurality of processes performed between a local exchange and an access network connected by a V5 interface, comprising the steps of: providing messages for synchronizing between the local exchange and the access network; and processing each of the plurality of processes synchronously based on the message.

For the conventional V5 specifications, which are unclear, a message used to synchronize the operations of the local exchange and the access network is defined so that the re-provisioning method (re-provisioning processes) can be performed by the local exchange and the access network.

For example, the first message is for the process for transiting synchronously the local exchange and the access network to ready state for starting the plurality of re-provisioning processes.

For example, the second message is for the second process for synchronously blocking ports of a plurality of subscriber terminals which are accommodated in the local exchange and the access network.

For example, the third message is for the third process for exchanging notifications for completion of re-provisioning process performed by the local exchange and the access network.

For example, the forth message is the forth process for synchronously unblocking ports of a plurality of subscriber terminals which are accommodated in the local exchange and the access network.

Finally, a network system to perform the re-provisioning method synchronously, is provided whereby a local exchange and an access network are connected to each other via a V5 interface.

### BRIEF DESCRIPTION OF THE DRAWINGS

FIGS. 1A and 1B are flowcharts showing synchronous re-provisioning processes employing a RE-PROVISIONING SYNCHRONIZED message according to a first embodiment of the present invention;

FIG. 2 is a diagram showing one part of the information elements included in a user port block message according to a second embodiment of the present invention;

FIG. 3 is a diagram showing an example frame structure for a user port repetition count information element;

FIG. 4 is a diagram showing an example frame structure for a user port mapping information element;

FIGS. 5A and 5B are flowcharts showing the synchronous re-provisioning processes which employs a message for the simultaneous blocking of a plurality of ports according to the second embodiment;

FIGS. 6A and 6B are flowcharts showing synchronous re-provisioning processes which employs a RE-PROVISIONING COMPLETED message according to a third embodiment of the present invention;

FIGS. 7A and 7B are flowcharts showing synchronous re-provisioning processes which employs a message for the simultaneous unblocking of a plurality of ports according to a fourth embodiment of the present invention;

FIGS. 8A and 8B are flowcharts showing the re-provisioning processes performed when an unblocking function is defined for a RE-PROVISIONING COMPLETED message;

FIGS. 9A and 9B are flowcharts showing the re-provisioning processes performed when a message used for start-up processes(method) is applied for the re-provisioning processes;

FIG. 10 is a diagram showing table 55 in chapter 14.5 of V5 specification ETS 300 324-1, which is changed in accordance with the first to the fourth embodiments of the present invention;

FIG. 11 is a diagram showing table 63 in chapter 14.5 of V5 specification ETS 300 324-1, which is changed in accordance with the first to the fourth embodiments of the present invention;

FIG. 12 is a diagram showing table 66 in chapter 14.5 of V5 specification ETS 300 324-1, which is changed in accordance with the first to the fourth embodiments of the present invention;

FIG. 13 is a diagram showing table 67 in chapter 14.5 of V5 specification ETS 300 324-1, which is changed in accordance with the first to the fourth embodiments of the present invention;

FIG. 14 is a specific diagram showing a network which includes local exchanges (LEs) and access networks (ANs);

FIG. 15 is a diagram showing a transfer format for 2.048 Mbps;

FIGS. 16A and 16B are flowcharts showing conventional re-provisioning processes;

FIG. 17 is a diagram showing conventional table 66 in chapter 14.5 of V5 specification ETS 300 324-1; and

FIG. 18 is a diagram showing conventional table 67 in chapter 14.5 of V5 specification ETS 300 324-1.

### DETAILED DESCRIPTION OF THE PREFERRED EMBODIMENTS

The preferred embodiments of the present invention will now be described while referring to the accompanying drawings. It should be noted, however, that the technical scope of the present invention is not limited to these embodiments.

[First Embodiment]

An innovative message to resolve the first problem is provided in a first embodiment of the present invention. That is, in the first embodiment the operations of an AN (access network) and an LE (local exchange) are synchronized to provide a re-provisioning synchronization message (RE-PROVISIONING SYNCHRONIZED) with which an event, “data set available,” is generated.

The AN and the LE generate the event, “data set available,” by exchanging the re-provisioning synchronization message (RE-PROVISIONING SYNCHRONIZED). Thus, the AN and the LE can respectively be transited from the state AN0 to the state AN1 and from the state LE0 to the state LE1.

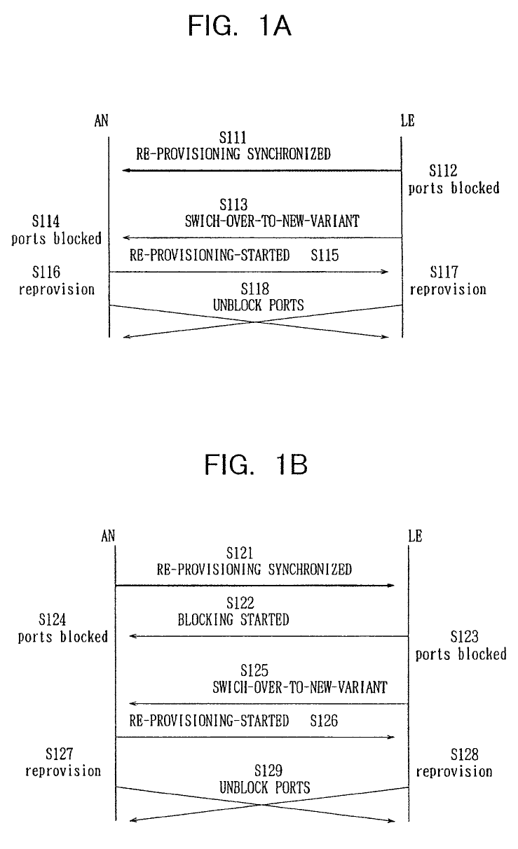

FIGS. 1A and 1B are flowcharts showing the re-provisioning processes performed using a re-provisioning synchronization message (RE-PROVISIONING SYNCHRONIZED) according to a first embodiment of the present invention. FIG. 1A is a flowchart showing the re-provisioning processes performed by the LE, and FIG. 1B is a flowchart showing the re-provisioning processes performed by the AN.

In FIG. 1A, first, at step S111 the LE transmits a re-provisioning synchronization message (RE-PROVISIONING SYNCHRONIZED) to the AN. In synchronization with the transmission of the re-provisioning synchronization message (RE-PROVISIONING SYNCHRONIZED), the LE generates the event, “data set available,” and is transited from the state LE0 to the state LE1. That is, the normal operating state is changed to the re-provisioning preparation completion state. At step S112 the ports of subscriber terminals which are affected by the re-provisioning processes are blocked (ports blocked).

Upon receiving the re-provisioning synchronization message (RE-PROVISIONING SYNCHRONIZED), the AN generates the event “data set available” and is transited from the state AN0 to AN1.

As is described above, since a new re-provisioning synchronization message (RE-PROVISIONING SYNCHRONIZED) is specified in the re-provisioning processes, the state transition of the LE and the AN can be performed synchronously.

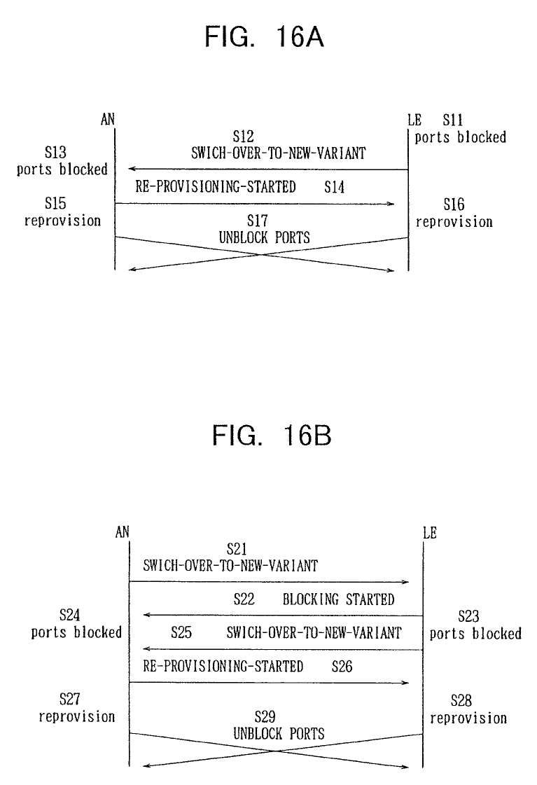

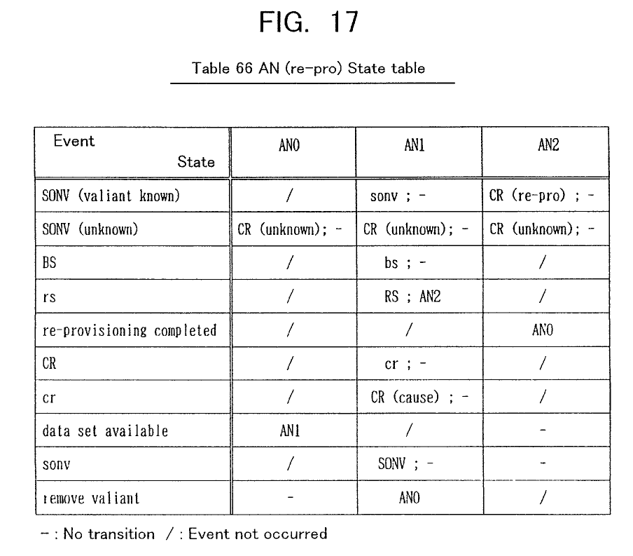

In FIG. 1B, at step S121 instead of a variant change message (SWITCH-OVER-TO-NEW-VARIANT) at step S21 in FIG. 16B, a re-provisioning synchronization message (RE-PROVISIONING SYNCHRONIZED) is transmitted from the AN to the LE.

In synchronization with the transmission of the re-provisioning synchronization message (RE-PROVISIONING SYNCHRONIZED), the AN generates the event “data set available” and is transited from the state AN0 to AN1.

Upon receiving the re-provisioning synchronization message (RE-PROVISIONING SYNCHRONIZED), the LE generates the event “data set available” and is transited from the state LE0 to LE1.

As is described above, since a new re-provisioning synchronization message (RE-PROVISIONING SYNCHRONIZED) is specified in the re-provisioning processes, the state transition of the LE and the AN can be performed synchronously.

Since steps S112 to S118 in FIG. 1A are the same as steps S11 to S17 in FIG. 16A, and steps S122 to S129 in FIG. 1B are the same as steps S22 to S29 in FIG. 16B, no explanation for them will be given.

[Second Embodiment]

An innovative message for resolving the second problem is provided in a second embodiment of the present invention. In the second embodiment, a message for simultaneously blocking a plurality of ports is provided.

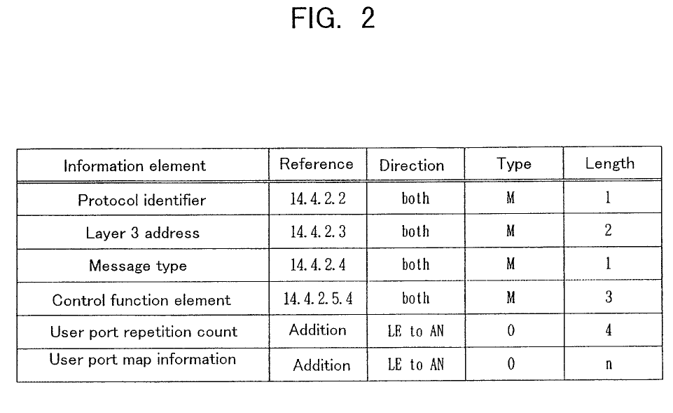

In the second embodiment, a user port block message (User port block), which is a message for a conventional V5 interface, is employed as the above message. FIG. 2 is a diagram showing one part of information element (IE) included in the user port block message (User port block) in the second embodiment. In FIG. 2, the user port block message (User port block) includes, as an information element (IE) for blocking subscriber terminals, a protocol identifier, a layer 3 address, a message type, a control function element, and a user port repetition count.

The protocol identifier is used to verify that the user port block message (User port block) is a V5 interface message.

The layer 3 address is an address used to designate support for an individual user.

Two message types are employed: a port control type and a common control type. The port control type is a message type for controlling the individual ports connected to the AN, and for it one layer 3 address is designated. The user port block message (User port block) is a port control type message.

The common control type is a message type for controlling the entire system for the V5 interface. This message type is used to activate (start-up) the system and to start the re-provisioning processes.

The control function element represents specific control contents transmitted with the message. The control contents defined are, for example, the activation and start (start-up) of the system, the start of re-provisioning processes, and the blocking or the unblocking of ports. Therefor, the control function element for blocking ports is set in the user port block message (User port block).

In the second embodiment, the user port repetition count is set for the user port block message (User port block) as an information element (IE) for establishing a plurality of ports to be blocked. The user port repetition count is a numeral used to designate an arbitrary port range for ports included among those constituting the plurality of ports (user ports) accommodated by the AN. Specifically, as the user port repetition count, a count of ports is established which includes ports in a range extending from one layer 3 address to the designated target port.

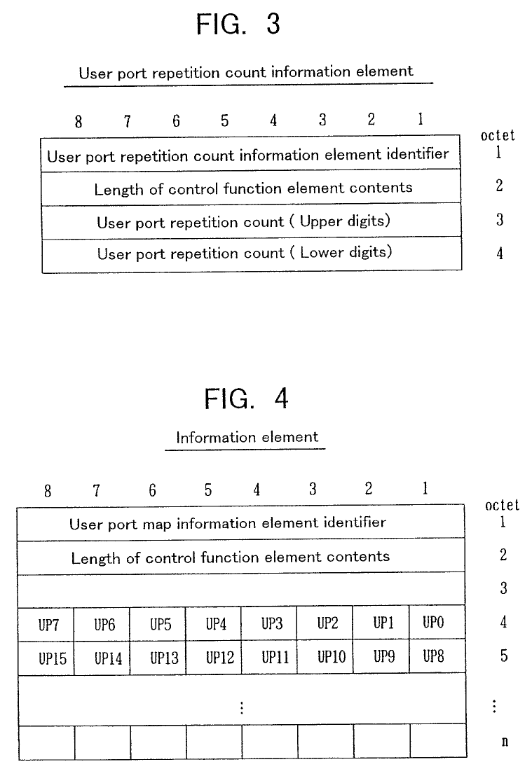

FIG. 3 is a diagram showing an example frame structure for a user port repetition count information element. In FIG. 3, the frame of the user port repetition count information element includes the user port repetition count information element identifier, the length of the user port repetition count information element (Length of Control function element contents) and the user port repetition count. When a numeral greater than 256 (8 bits) is set as the user port repetition count, as is shown in FIG. 3, a plurality of octets are used as areas for setting the user port repetition count. In FIG. 3, the upper digits of the user port repetition count are set in the third octet, and the lower digits are set in the fourth octet.

In addition, all the ports may be designated by setting the user port repetition count to “0.”

Further, instead of the user port repetition count, a user port map information element may be included in the user port block message (User port block) in the second embodiment. The user port map information element is an information element (IE) for designating the address of an arbitrary port selected from among the ports accommodated by the AN.

FIG. 4 is a diagram showing the frame structure of the user port map information element. In FIG. 4, a user port map information element identifier, the length of the user port map information element (Length of Control function element contents), and flag information for each port are included in the frame of the user port map information element.

In FIG. 4, UP0, UP1, . . . are areas in which is set flag information indicating whether a user port corresponding to each number is to be blocked. A port for which the flag information “block” is set is blocked. Since the flag information is set in this manner, an arbitrary port which is to be blocked can be selected.

In the second embodiment, the user port block message (User port block), which additionally includes the user port repetition count information element or the user port map information element, is employed as a message for the blocking of a plurality of ports.

Furthermore, in the second embodiment, the user port repetition count information element, or the user port map information element may be additionally included in the blocking start message (BLOCKING STARTED), which is specified in the conventional re-provisioning processes, instead of the conventional user port block message (User port block).

Further, in the second embodiment, instead of the user port block message (User port block), or the blocking start message (BLOCKING STARTED), a new message for blocking a plurality of ports may be specified during the re-provisioning processes. For example, a partial user port block message (PARTIAL USER PORT BLOCKED) is defined as a message for blocking one part of a plurality of ports accommodated by the AN. In addition, an all user port blocking message (ALL USER PORT BLOCKED), for example, is defined as a message for blocking all the ports accommodated by the AN.

The user port repetition count information element or the user port map information element is set in the partial user port blocking message (PARTIAL USER PORT BLOCKED), and the address of a port to be blocked is designated.

Since an all user port blocking message (ALL USER PORT BLOCKED) is a message for blocking all the ports, it does not include the user port repetition information element and the user port map information element used to designate a user port.

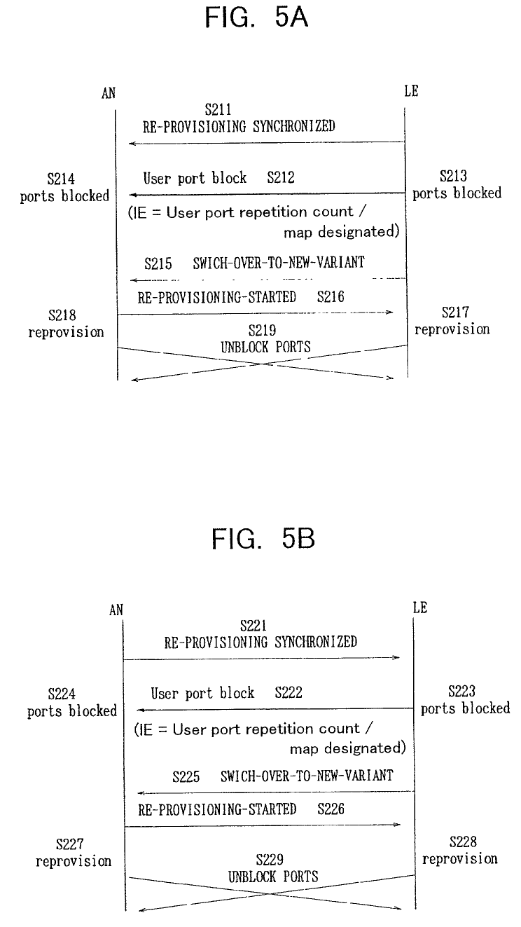

FIGS. 5A and 5B are flowcharts for the re-provisioning processes, according to the second embodiment, which uses a message to initiate the simultaneous blocking of a plurality of ports. In FIGS. 5A and 5B, the user port block message (User port block), which additionally includes the user port repetition count information element or the user port map information element, is employed as a message for the simultaneous blocking of a plurality of ports. FIG. 5A is a flowchart showing the re-provisioning processes performed by the LE, and FIG. 5B is a flowchart showing the re-provisioning processes performed by the AN.

In FIG. 5A, at step S211 the LE transmits to the AN a re-provisioning synchronization message (RE-PROVISIONING SYNCHRONIZED) of the first embodiment.

At step S212, the LE transmits to the AN a user port block message (User port block), which includes the user port repetition count information element in FIG. 3 or the user port map information element in FIG. 4. At step S213, or S214 the LE and the AN block ports designated to be blocked in the user port block message (User port block) are blocked.

Further, after the blocking process has been completed, at step S215 the LE transmits to the AN a variant change message (SWITCH-OVER-TO-NEW-VARIANT).

Upon receiving the variant change message (SWITCH-OVER-TO-NEW-VARIANT), at step S216 the AN transmits the re-provisioning start message (RE-PROVISIONING-STARTED) to the LE, and at step S218 starts the re-provisioning process. Upon receiving the re-provisioning start message (RE-PROVISIONING-STARTED), at step S217 the LE starts the re-provisioning process.

After the re-provisioning process is completed, at step S219 the LE and the AN exchange port unblocking messages (UNBLOCK-PORTS). Both the LE and the AN, each upon receiving the port unblocking message (UNBLOCK-PORTS) forwarded by the other, release the blocking imposed on (unblock) the ports. Thereafter the re-provisioning processes are terminated.

As for FIG. 5B, at step S221 the AN transmits to the LE the re-provisioning synchronization message (RE-PROVISIONING SYNCHRONIZED) of the first embodiment. Since steps S222 to S229 are the same as steps S212 to S219, no explanation for them will be given.

[Third Embodiment]

An innovative message for resolving the third problem is provided in a third embodiment. In the third embodiment, the AN and the LE synchronously exchange the re-provisioning completion message (RE-PROVISIONING COMPLETED) to generate the event “Re-provisioning completed.”

The AN and the LE re-provisioning completion messages (RE-PROVISIONING COMPLETED) are messages by which each notifies the other that the re-provisioning has been completed at their location.

The AN and the LE exchange the re-provisioning completion messages (RE-PROVISIONING COMPLETED) to generate the event “re-provisioning completed.” Thus, the AN and the LE can respectively be transited from the state AN2 to the state AN0 and from the state LE3 to the state LE0. In other words, the AN and the LE can be transited from the re-provisioning processes state to the normal operating state.

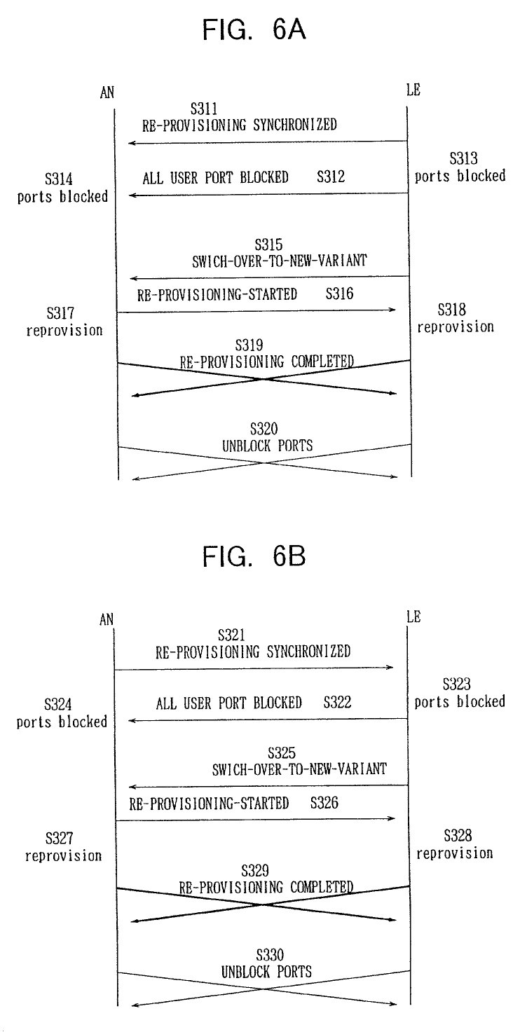

FIGS. 6A and 6B are flowcharts showing the re-provisioning processes employing the re-provisioning completion message (RE-PROVISIONING COMPLETED) in the third embodiment. FIG. 6A is a flowchart showing the re-provisioning processes performed by the LE and FIG. 6B is a flowchart showing the re-provisioning processes performed by the AN.

In FIG. 6A, at step S311 the LE transmits to the AN the re-provisioning synchronization message (RE-PROVISIONING SYNCHRONIZED) of the first embodiment.

To block all the ports of the subscriber terminal, at step S312 the LE transmits to the AN, for example, the all user port blocking message (ALL USER PORT BLOCKED) of the second embodiment. At steps S313 and S314, the LE and the AN block all the ports based on the all user port blocking message (ALL USER PORT BLOCKED).

When the blocking process has been completed, at step S315 the LE transmits to the AN the variant change message (SWITCH-OVER-TO-NEW-VARIANT).

Upon receiving the variant change message (SWITCH-OVER-TO-NEW-VARIANT), at step S316 the AN transmits the re-provisioning start message (RE-PROVISIONING-STARTED) to the LE, and at step S317 starts the re-provisioning process. Upon receiving the re-provisioning start message (RE-PROVISIONING-STARTED), at step S318 the LE starts the re-provisioning process.

In the third embodiment, when the re-provisioning process has been completed, at step S319 the AN and the LE exchange re-provisioning completion messages (RE-PROVISIONING COMPLETED) to notify each other that the re-provisioning process has been completed at their location.

Since the AN and the LE exchange the re-provisioning completion messages (RE-PROVISIONING COMPLETED), the two are respectively transited from the state AN2 to the state AN0 and from the state LE3 to the state LE0.

At step S320 the AN and the LE exchange port unblocking messages (UNBLOCK-PORTS), and unblock those ports which have been blocked. The re-provisioning processes are thereafter terminated.

As for FIG. 6B, at step S321 the AN transmits to the LE the re-provisioning synchronization message (RE-PROVISIONING SYNCHRONIZED) of the first embodiment. Since steps S322 to S330 are the same as steps S312 to S320, no explanation for them will be given.

[Fourth Embodiment]

An innovative message for resolving the fourth problem is provided in a fourth embodiment of the present invention. In the fourth embodiment, a message for the simultaneous unblocking of a plurality of ports is provided.

In this embodiment, a user port unblock message (User port unblock), which is a message for the conventional V5 interface, is employed as the message for the simultaneous unblocking of a plurality of ports. The user port unblock message (User port unblock) in this embodiment includes the same information element as does the user port unblock message (User port block) in FIG. 2.

Specifically, in the fourth embodiment, the user port unblock message (User port unblock) includes the user port repetition count information element in FIG. 3, or the user port map information element in FIG. 4. A control function element for unblocking ports is set in the information element (IE).

Since the port repetition count information element, or the user port map information element is set in the user port unblock message (User port unblock) like to the user port block message (User port block) in the second embodiment, a plurality of ports can be simultaneously unblocked.

In the fourth embodiment, instead of the user port unblock message (User port unblock), a new message for unblocking a plurality of ports may be defined. For example, a partial user port unblock message (PARTIAL USER PORT UNBLOCKED) is defined as a message for unblocking one part of a plurality of ports accommodated by the AN. In addition, an all user port unblock message (ALL USER PORT UNBLOCKED) is defined as a message for unblocking all the ports accommodated by the AN.

Furthermore, the user port repetition count information element, or the user port map information element is set, and the addresses of ports to be unblocked are designated, in the partial user port unblock message (PARTIAL USER PORT UNBLOCKED).

Since the all user port unblock message (ALL USER PORT UNBLOCKED) is a message for unblocking all the ports, it does not include the user port repetition count information element, and the user port map information element, which is used for designating ports.

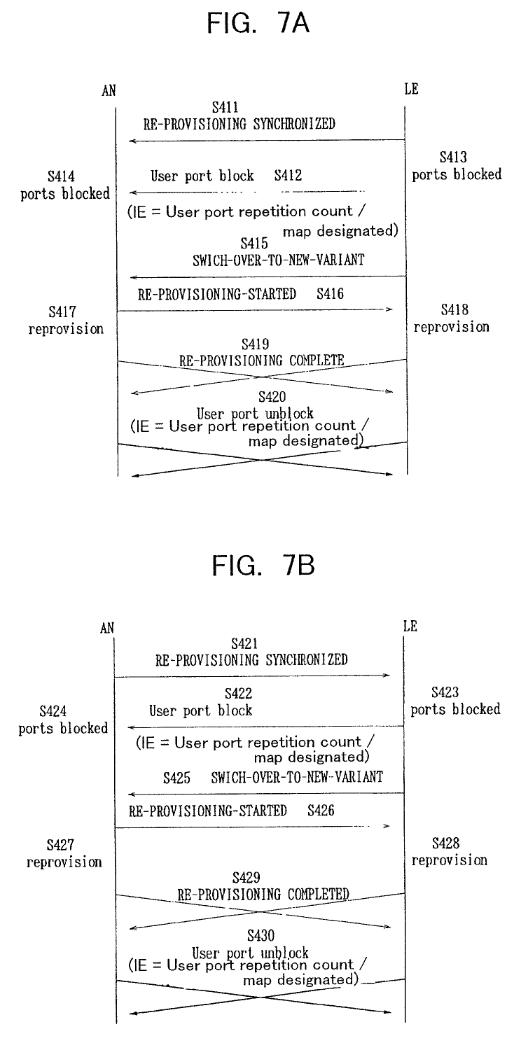

FIGS. 7A and 7B are flowcharts showing the re-provisioning processes performed in the fourth embodiment by employing the message for the simultaneous unblocking of a plurality of ports. In FIGS. 7A and 7B, the user port unblock message (User port unblock), which additionally includes the user port repetition count information element or the user port map information element, is employed as the message for the simultaneous unblocking of a plurality of ports. FIG. 7A is a flowchart showing the re-provisioning processes performed by the LE, and FIG. 7B is a flowchart showing the re-provisioning processes performed by the AN.

In FIG. 7A, at step S411 the LE transmits to the AN a re-provisioning synchronization message (RE-PROVISIONING SYNCHRONIZED) of the first embodiment.

At step S412, the LE transmits to the AN the user port block message (User port block) of the second embodiment. At step S413 and S414 the LE and the AN block the ports which are designated in the user port block message.

Then, after the blocking process has been completed, at step S415 the LE transmits to the AN a variant change message (SWITCH-OVER-TO-NEW-VARIANT).

Upon receiving the variant change message (SWITCH-OVER-TO-NEW-VARIANT), at step S416 the AN transmits the re-provisioning start message (RE-PROVISIONING-STARTED) to the LE, and at step S417 starts the re-provisioning process. Upon receiving the re-provisioning start message (RE-PROVISIONING-STARTED), at step 418 the LE starts the re-provisioning process.

When the re-provisioning process has been completed, at step S419 the AN and the LE exchange re-provisioning completion messages (RE-PROVISIONING COMPLETED) to notify each other that the re-provisioning process has been completed at their location.

Since the AN and the LE exchange the re-provisioning completion messages (RE-PROVISIONING COMPLETED), the two are transited respectively from the state AN2 to the state AN0 and from the state LE3 to the state LE0.

After the re-provisioning process is completed, at step S420 the LE and the AN exchange user port unblocking messages (User port unblock). Both the LE and the AN, each upon receiving the user port unblocking message (User port unblock) forwarded by the other, release the blocking imposed on (unblock) the ports. Thereafter the re-provisioning processes are terminated.

As for FIG. 7B, at step S421 the AN transmits to the LE the re-provisioning synchronization message (RE-PROVISIONING SYNCHRONIZED) of the first embodiment. Since steps S422 to S430 are the same as the above described steps S412 to S420, no explanation for them will be given.

In the fourth embodiment, the re-provisioning completion message (RE-PROVISIONING COMPLETED) of the third embodiment may be employed as a message for unblocking a plurality of ports. Then the unblocking function is defined in the re-provisioning completion message (RE-PROVISIONING COMPLETED), and the user port repetition count information element in FIG. 3, or the user port map information element in FIG. 4, is added as an information element.

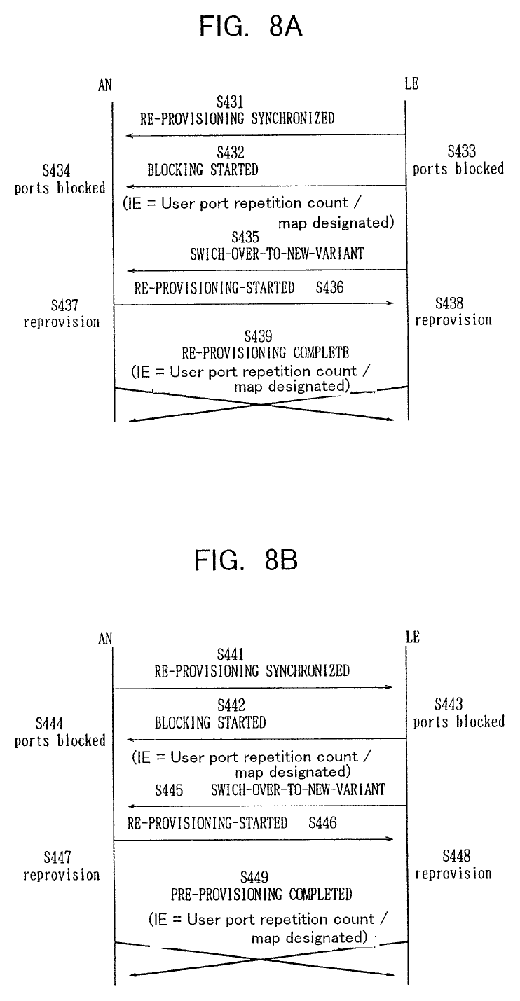

FIGS. 8A and 8B are flowcharts showing the re-provisioning processes when the unblocking function is defined in the re-provisioning completion message (RE-PROVISIONING COMPLETED). FIG. 8A is a flowchart showing the re-provisioning processes performed by the LE, and FIG. 8B is a flowchart showing the re-provisioning processes performed by the AN.

In FIG. 8A, at step S431 the LE transmits to the AN a re-provisioning synchronization message (RE-PROVISIONING SYNCHRONIZED) for the first embodiment.

At step S432, the LE transmits to the AN, for example, the block start message (BLOCKING STARTED) of the second embodiment. At step S433 and S434 the LE and the AN respectively block the ports designated in the block start message (BLOCKING STARTED).

Then, after the blocking process has been completed, at step S435 the LE transmits to the AN a variant change message (SWITCH-OVER-TO-NEW-VARIANT).

Upon receiving the variant change message (SWITCH-OVER-TO-NEW-VARIANT), at step S436 the AN transmits the re-provisioning start message (RE-PROVISIONING-STARTED) to the LE, and at step S437 starts the re-provisioning process. Upon receiving the re-provisioning start message (RE-PROVISIONING-STARTED), at step S438 the LE starts the re-provisioning process.

When the re-provisioning process is completed, at step S439 the AN and the LE exchange re-provisioning completion messages (RE-PROVISIONING COMPLETED) to notify each other that the re-provisioning process has been completed at their location.

Since the AN and the LE exchange the re-provisioning completion messages (RE-PROVISIONING COMPLETED), the two are respectively transited from the state AN2 to the state AN0 and from the state LE3 to the state LE0.

Then, the AN and the LE unblock the ports designated in the user port repetition count information element, or the user port map information element, which is included in the re-provisioning completion message (RE-PROVISIONING COMPLETED). Since the port unblocking function is defined in the re-provisioning completion message (RE-PROVISIONING COMPLETED), the ports can be unblocked without an unblocking message being required.

As for FIG. 8B, at step S441 the AN transmits to the LE the re-provisioning synchronization message (RE-PROVISIONING SYNCHRONIZED) of the first embodiment. Since steps S442 to S449 are the same as the above described steps S432 to S439, no explanation for them will be given.

In the fourth embodiment, the following four messages, which are employed during the start-up processes (method) for the conventional V5 interface, may be employed as messages for unblocking all the ports in the re-provisioning processes.

The four messages used for the start-up processes (method) are:

all relevant ports unblock request message (UNBLOCK ALL RELEVANT PORTS REQUEST);

all relevant ports unblock rejection message (UNBLOCK ALL RELEVANT PORTS REJECTED);

all relevant ports unblock acceptance message (UNBLOCK ALL RELEVANT PORTS ACCEPTED); and

all relevant ports unblock completion message (UNBLOCK ALL RELEVANT PORTS COMPLETED).

The all relevant ports unblock request message (UNBLOCK ALL RELEVANT PORTS REQUEST) is a message used to request the unblocking of all the ports. The all relevant ports unblock rejection message (UNBLOCK ALL RELEVANT PORTS REJECTED) is a message for, in response to the all relevant ports unblock request message (UNBLOCK ALL RELEVANT PORTS REQUEST), rejecting the unblocking of ports due to the occurrence of a specific barrier. The all relevant ports unblock acceptance message (UNBLOCK ALL RELEVANT PORTS ACCEPTED) is a message for, in response to the all relevant ports unblock request message (UNBLOCK ALL RELEVANT PORTS REQUEST), tendering notification that the request has been accepted. The all relevant ports unblock completion message (UNBLOCK ALL RELEVANT PORTS COMPLETED) is a message for tendering notification that the unblocking process has been completed for all the ports.

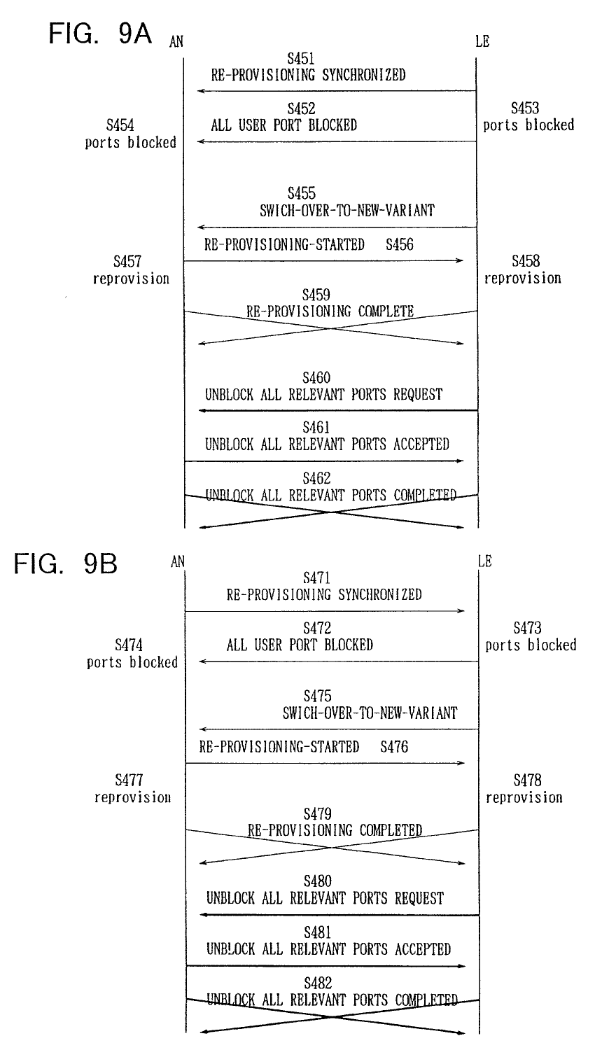

FIGS. 9A and 9B are flowcharts showing the re-provisioning processes for which are employed the above four messages which are used in the start-up processes. FIG. 9A is a flowchart showing the re-provisioning processes performed by the LE, and FIG. 9B is a flowchart showing the re-provisioning processes performed by the AN.

In FIG. 9A, at step S451 the LE transmits to the AN a re-provisioning synchronization message (RE-PROVISIONING SYNCHRONIZED) for the first embodiment.

At step S452, the LE transmits to the AN, for example, the block start message (BLOCKING STARTED) of the second embodiment. At step S453 and S454 the LE and the AN block the ports designated in the block start message (BLOCKING STARTED).

Then, after the blocking process has been completed, at step S455 the LE transmits to the AN a variant change message (SWITCH-OVER-TO-NEW-VARIANT).

Upon receiving the variant change message (SWITCH-OVER-TO-NEW-VARIANT), at step S456 the AN transmits the re-provisioning start message (RE-PROVISIONING-STARTED) to the LE, and at step S457 starts the re-provisioning process. Upon receiving the re-provisioning start message (RE-PROVISIONING-STARTED), at step S458 the LE starts the re-provisioning process.

When the re-provisioning process is completed, at step S459 the AN and the LE exchange re-provisioning completion messages (RE-PROVISIONING COMPLETED) to notify each other that the re-provisioning process has been completed at their location.

Since the AN and the LE exchange the re-provisioning completion messages (RE-PROVISIONING COMPLETED), the two are transited respectively from the state AN2 to the state AN0 and from the state LE3 to the state LE0.

Then, after the AN and the LE exchange re-provisioning completion messages (RE-PROVISIONING COMPLETED), at step S460 the LE begins to unblock all the ports, and transmits to the AN the all relevant ports unblock request message (UNBLOCK ALL RELEVANT PORTS REQUEST) to request the unblocking of all the ports. At step S461, the AN returns to the LE the all relevant ports unblock acceptance message (UNBLOCK ALL RELEVANT PORTS ACCEPTED), which indicates that the unblocking request from the LE has been accepted, and begins to unblock all the ports. When the LE and the AN have unblocked all the ports, at step S462 they exchange all relevant ports unblock completion messages (UNBLOCK ALL RELEVANT PORTS COMPLETED), which indicate that all the ports have been unblocked.

As for FIG. 9B, at step S471 the AN transmits to the LE the re-provisioning synchronization message (RE-PROVISIONING SYNCHRONIZED) of the first embodiment. Since steps S472 to S482 are the same as the above described steps S452 to S462, no explanation for them will be given.

When chapter 14.5 of the V5 specification ETS 300 324-1 and chapter 15.5 of the ETS 300 347-1, in which the re-provisioning processes are defined, are changed according to the above described first to fourth embodiments, the re-provisioning processes performed synchronously by the LE and the AN can be implemented.

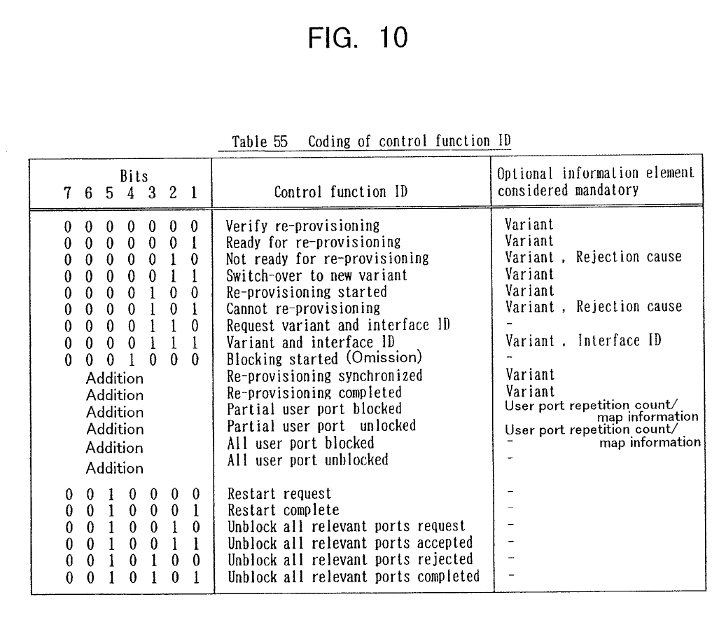

FIG. 10 is a table 55 extracted from chapter 14.5 of the V5 specification ETS 300 324-1 which is changed according to the first to the fourth embodiments. In table 55 are shown bit strings for the control function elements (Control function IDs) for the common control types selected from among the information elements in FIG. 2.

In FIG. 10, the following control function elements (Control function IDs) are additionally provided:

Re-provisioning synchronized . . . (1)

Re-provisioning completed . . . (2)

Partial user port blocked . . . (3)

Partial user port unblocked . . . (4)

All user port blocked . . . (5)

All user port unblocked . . . (6),

which correspond to the following messages defined in the first to the fourth embodiments:

re-provisioning synchronization message (RE-PROVISIONING SYNCHRONIZED);

re-provisioning completion message (RE-PROVISIONING COMPLETED);

partial user port block message (PARTIAL USER PORT BLOCKED);

partial user port unblock message (PARTIAL USER PORT UNBLOCKED);

all user port block message (ALL USER PORT BLOCKED); and

all user port unblocked message (ALL USER PORT UNBLOCKED).

Furthermore, the control function element (Control function ID) “Blocking started” is deleted.

If to block and unblock the ports the user port block message (User port block) and the user port unblock message (User port unblock), to which the user port repetition count or the user port map information is added, are employed in the second and the fourth embodiments, control function elements (Control function IDs) (3) to (6) may not be added.

Further, if to block and unblock the ports the block start message (BLOCKING STARTED) is employed in the second and the fourth embodiments, control function element (Control function ID) “Blocking started” is not deleted. Also, the control function elements (Control function IDs) (3) to (6) are not added.

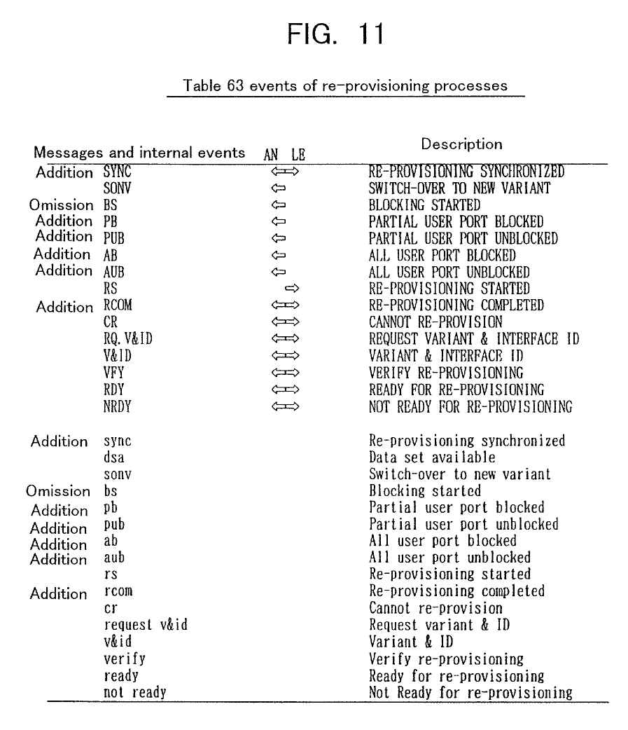

FIG. 11 is a table 63 extracted from chapter 14.5 of the V5 specification ETS 300 324-1 which is changed according to the first to the fourth embodiment. In table 63 are shown events that occur during the re-provisioning processes. In FIG. 11 upper case character entries represent messages exchanged by the LE and the AN, and lower case characters entries represent internal events which are internally generated by the LE and the AN.

In FIG. 11, additionally provided are the following messages defined in the first to the fourth embodiments:

SYNC (re-provisioning synchronization message) . . . (7)

RCOM (re-provisioning completion message) . . . (8)

PB (partial user ports block message) . . . (9)

PUB (partial user ports unblock message) . . . (10)

AB (all user ports block message) . . . (11)

AUB (all user ports unblock message) . . . (12),

and the following corresponding internal events:

sync (re-provisioning synchronization) . . . (13)

rcom (re-provisioning completion) . . . (14)

pb (partial user ports block) . . . (15)

pub (partial user ports unblock) . . . (16)

ab (all user ports block) . . . (17)

aub (all user ports unblock) . . . (18).

Furthermore, the blocking start message (BLOCKING STARTED) and its corresponding internal event “Blocking started” are deleted. If to block and unblock the ports the user port block message (User port block) and the user port unblock message (User port unblock), to which is added the user port repetition count or the user port map information, are employed in the second and the fourth embodiments, the above messages (9) to (12) and the internal events (15) to (18) may not be added.

Further, if to block and unblock the ports the block start message (BLOCKING STARTED) is employed in the second and the fourth embodiments, the blocking start message (BLOCKING STARTED) and the corresponding internal event “Blocking started” are not deleted. Also, the messages (9) to (12) and the internal events (15) to (18) are not added.

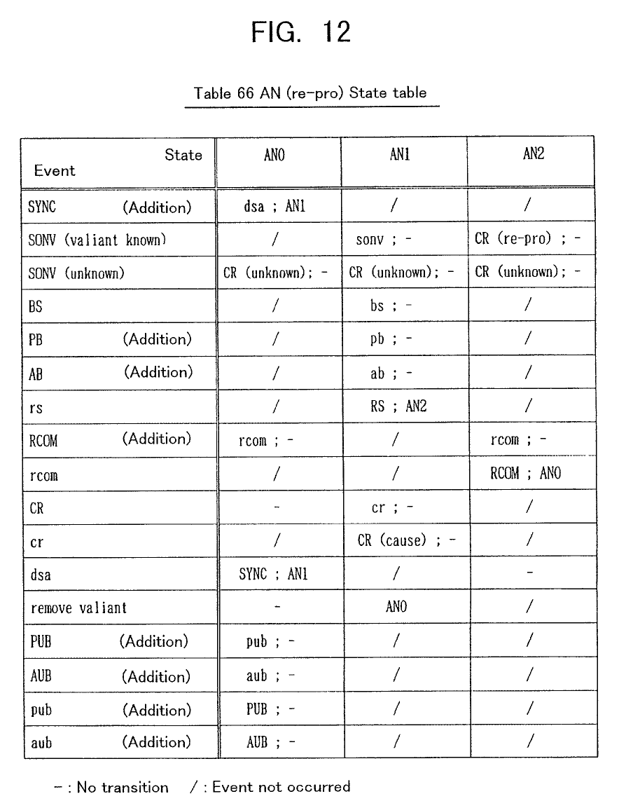

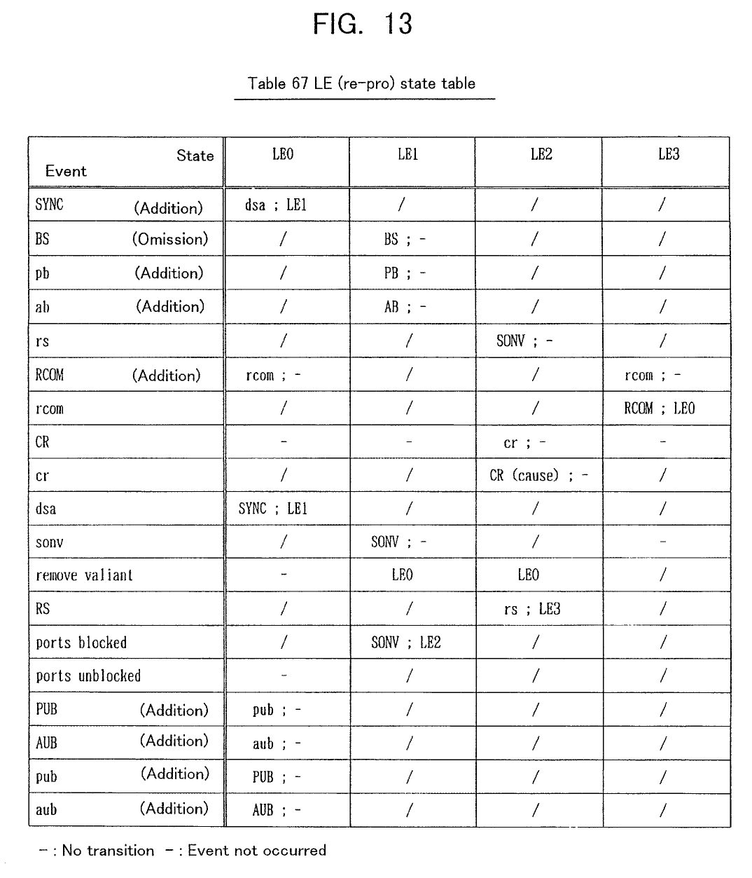

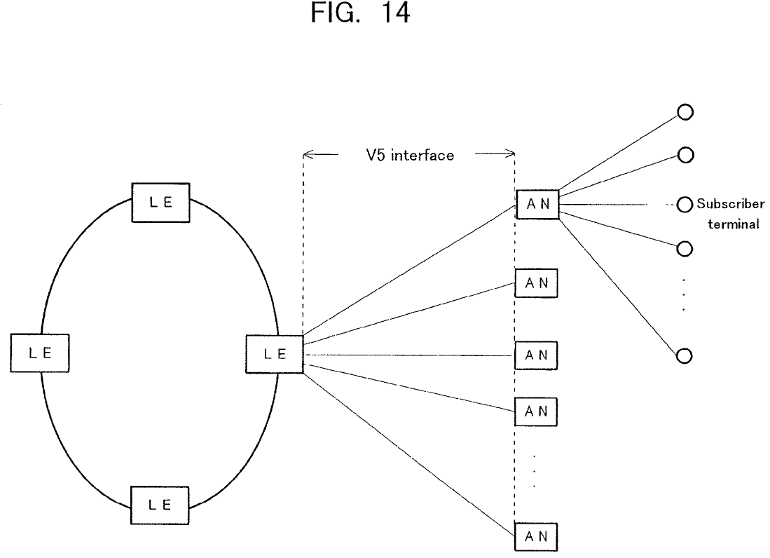

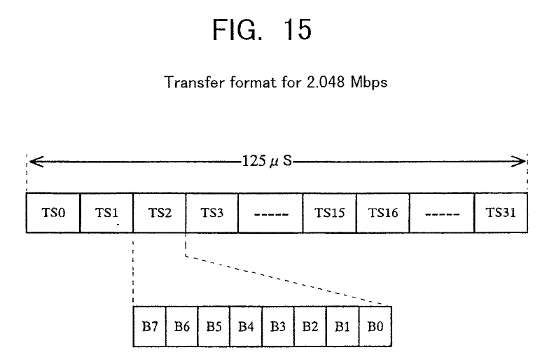

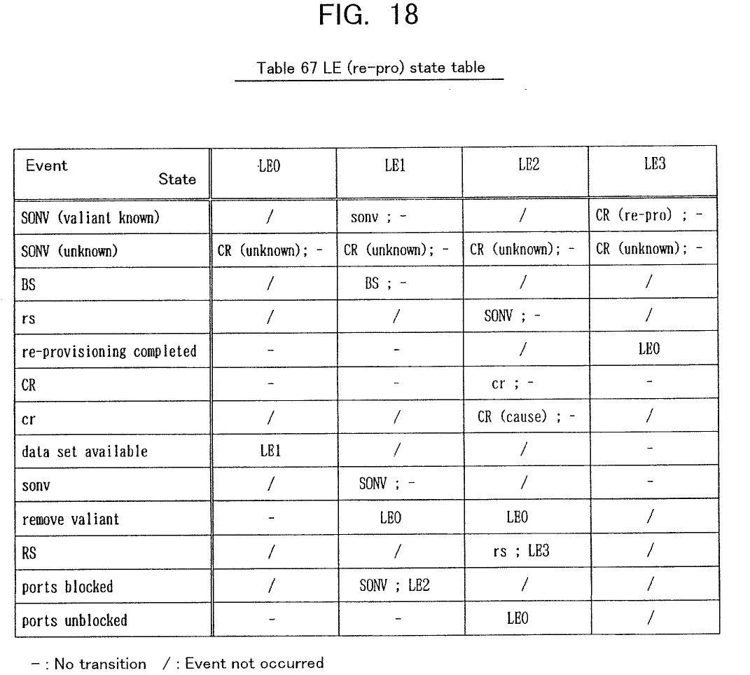

FIGS. 12 and 13 are tables 66 and 67 extracted from chapter 14.5 of the V5 specification ETS 300 324-1 which are changed according to the first to the fourth embodiment. The tables 66 and 67 show the states of the AN and the LE which are to be transited in accordance with individual events. Therefore, FIGS. 12 and 13 correspond to FIGS. 17 and 18 which show the conventional tables 66 and 67 extracted from chapter 14.5 in the V5 specification ETS 300 324-1.

As is apparent from the comparison of FIG. 12 with FIG. 17 and of FIG. 13 with FIG. 18, in FIGS. 12 and 13 are shown the state transition of the AN and the LE in accordance with the events added in FIG. 11. Specifically, in FIG. 12 added are the states of the AN which correspond to events SYNC, PB, AB, RCOM, PUB, AUB, pub and aub. In FIG. 13 the states of the LE are added which correspond to events SYNC, Pb, ab, RCOM, PUB, AUB, pub and aub.

Further, in FIGS. 12 and 13 the occurrence of state transition in response to the event RCOM (re-provisioning completion message (RE-PROVISIONING COMPLETED)) is described as the state for the event rcom. Also, the occurrence of state transition in response to the event SYNC (re-provisioning synchronization message (RE-PROVISIONING SYNCHRONIZED)) is described as the state for the event dsa.

As is described above, according to the present invention, a new message is defined for a unclear portion in the conventional V5 interface re-provisioning processes(method), so that re-provisioning processes (method) synchronously performed by the local exchange (LE) and the access network (AN) can be implemented.

The present invention may be embodied in other specific forms without departing from the spirit or essential characteristics thereof. The present embodiment is therefore to be considered in all respects as illustrative and not restrictive, the scope of the invention being indicated by the appended claims rather than by foregoing description and all change which come within the meaning and range of equivalency of the claims are therefore intended to be embraced therein.

What is claimed is:

1. A re-provisioning method including a plurality of processes performed between a local exchange and an access network connected by a V5 interface comprising the steps of:
providing messages for synchronizing between the local exchange and the access network; and
processing each of the plurality of processes synchronously based on the message.

2. The re-provisioning method according to claim 1, wherein the first message is for the first process for transiting synchronously the local exchange and the access network to ready state for starting the plurality of re-provisioning processes.

3. The re-provisioning method according to claim 1, wherein the second message is for the second process for synchronously blocking ports of a plurality of subscriber terminals which are accommodated in the local exchange and the access network.

4. The re-provisioning method according to claim 3, wherein the second message includes an information element for designating a part of the ports.

5. The re-provisioning method according to claim 3, wherein the second message includes an information element for designating all the ports.

6. The re-provisioning method according to claim 1, wherein the third message is the third process for exchanging notifications for completion of re-provisioning process performed by the local exchange and the access network.

7. The re-provisioning method according to claim 1, wherein the forth message is for the forth process for synchronously unblocking ports of a plurality of subscriber terminals which are accommodated in the local exchange and the access network.

8. The re-provisioning method according to claim 7, wherein the forth message includes an information element for designating a part of the ports.

9. The re-provisioning method according to claim 7, wherein the forth message includes an information element for designating all the ports.

10. The re-provisioning method according to claim 1, wherein a message provided for a start-up method in V5 interface is applied as the message for unblocking the ports of a plurality of subscriber terminals which are accommodated in the local exchange and the access network, and unblocking of the ports is performed synchronously based on the message.

11. The re-provisioning method according to claim 6, wherein a function for unblocking the ports is defined in the third message, and unblocking of the ports is performed synchronously based on the third message.

12. A network system including a local exchange and an access network connected by V5 interface each other, wherein the local exchange and the access network process each of a plurality of re-provisioning processes synchronously based on messages for synchronizing between the local exchange and the access network.

13. The network system according to claim 12, wherein the first message is for the first process for transiting synchronously the local exchange and the access network to ready state for starting the plurality of re-provisioning steps.

14. The network system according to claim 12, wherein the second message is the second process for synchronously blocking the ports of a plurality of subscriber terminals which are accommodated in the local exchange and the access network.

15. The network system according to claim 14, wherein the second message includes an information element for designating a part of the ports.

16. The network system according to claim 14, wherein the second message includes an information element for designating all the ports.

17. The network system according to claim 12, wherein the third message is the third process for exchanging notifications for completion of re-provisioning process performed by the local exchange and the access network.

18. The network system according to claim 12, wherein the forth message is for the forth process for synchronously unblocking ports of a plurality of subscriber terminals which are accommodated in the local exchange and the access network.

19. The network system according to claim 18, wherein the forth message includes an information element for designating a part of the ports.

20. The network system according to claim 18, wherein the forth message includes an information element for designating all the ports.
